(19) United States
(12) Patent Application Publication
(10) Pub. No.: US 2009/0199719 A1
(43) Pub. Date: Aug. 13, 2009

(54) DOUBLE-WALLED VESSEL

(75) Inventor: Jorgen Bodum, Meggen (CH)

Correspondence Address: SUGHRUE MION, PLLC, 2100 PENNSYLVANIA AVENUE, N.W., SUITE 800, WASHINGTON, DC, 20037, US

(73) Assignee: PI-DESIGN AG, Triengen (CH)

(21) Appl. No.: 12/281,865

(22) PCT Filed: Aug. 4, 2006
(86) PCT No.: PCT/CH2006/000408

§ 371 Date: Sep. 5, 2008

(30) Foreign Application Priority Data
Mar. 7, 2006 (CH) 358/06

(51) Int. Cl. A23L 1/00; C03B 23/20

(52) U.S. Cl. 99/275; 65/36; 65/42

(57) ABSTRACT

The invention discloses a glass vessel for a beverage-making machine, which glass vessel is at least partly of double-walled design. In a first refinement, an inner part (1) projects beyond an outer part (2) which partly surrounds said inner part, with the result that a double-walled lower region (100) and a single-walled upper region (101) with a pouring region (13) arranged therein are provided. In another refinement, the inner part and outer part are connected at their upper edge, and the pouring region is of double-walled design. The invention also specifies a method for producing the vessel.

### TECHNICAL FIELD OF THE INVENTION

The present invention relates to a glass vessel for a beverage-making device.

### PRIOR ART

From the prior art, so-called “French press” coffee-making devices are known. These devices generally have a cylindrical, tall glass vessel and a plunger filter which can be displaced therein and which can be pushed down in the glass vessel by means of a piston rod. In order to prepare coffee, coffee powder is added to the vessel and brewed using hot water. The mixture is left to stand for a few minutes. The plunger filter is then pushed down. By driving the coffee powder to the bottom of the vessel, the plunger filter separates the leached coffee powder from the finished coffee beverage. In a similar way, tea etc. can also be prepared instead of coffee.

One disadvantage of such beverage-making devices is that the prepared hot beverage cools down quickly. In addition, there is a risk of the glass vessel breaking due to improper handling and as a result the hot liquid therein escaping and scalding the user. This may have very serious health consequences.

### DESCRIPTION OF THE INVENTION

It is therefore an object of the present invention to provide a glass vessel for use in a beverage-making device of the type mentioned in the introduction which firstly prevents the hot beverage from cooling down quickly and secondly provides improved security in case that the glass should break. This object is achieved by a glass vessel as claimed in claim 1.

A further object of the present invention is to provide a method for producing a glass vessel of this type. This object is achieved by a method as claimed in claim 13. Advantageous embodiments are specified in the dependent claims.

The glass vessel of the present invention has at least one double-walled region. As a result, firstly the process of cooling down is slowed down since the intermediate space between the walls has an insulating effect. Secondly, the double-walled configuration provides improved protection in case that the glass should break. The double-walled region protects the user against escaping liquid if the side wall of the inner or outer part should burst. Escaping hot liquid is then retained by the part which is still intact. As a result, the risk of injury to the user is reduced.

U.S. Pat. No. 6,405,892 discloses various double-walled vessels for domestic use. For example, a double-walled cup is described. In this case, an inner part is inserted into an outer part. A thread for a screw connection is arranged both on the inner part and on the outer part. The inner part is connected to the outer part by means of this screw connection. The connection between the outer part and the inner part is additionally sealed by a sealing element. Production of a double-walled vessel of this type is relatively complicated. Specifically, it is particularly complicated to produce a suitable thread, to attach the sealing element and to subsequently screw the two parts together.

This is all the more true if the double-walled vessel has to be manufactured from glass, since glass is disproportionately more difficult to shape than plastic. The present invention shows ways of overcoming these difficulties.

The glass vessel preferably has an inner part and an outer part which at least partly surrounds said inner part, which inner part and outer part are fused to one another. The inner part and/or the outer part is preferably configured such that it tapers toward the other part in its upper edge region. In this way, these two parts can be fused to one another without adversely affecting the measuring accuracy at more remote points.

The inner part preferably widens in an upper edge region. This makes it easier to insert a plunger filter.

In a first preferred embodiment, the vessel has a single-walled upper region and a double-walled lower region. As a result, the glass vessel can be produced in a simple manner.

A spout shape, in particular in the form of an outwardly projecting nozzle, is preferably formed in the single-walled upper region. This is very easily possible since the corresponding region has only one wall. On account of this spout shape, the liquids can be removed from the glass vessel in a simple and neat manner.

The glass vessel preferably has a circular-cylindrical inner surface. The circular-cylindrical inner surface is advantageous if the vessel is used as a coffee or tea maker. A plunger filter/filter piston can then be inserted into the glass vessel in a simple manner and displaced therein. The circular-cylindrical inner surface ensures a particularly reliable seal, particularly at the sealing point at the edge of the filter piston and the inner surface.

In a preferred embodiment, the glass vessel comprises an inner part with a bottom and a circumferential cylindrical side wall which has an upper edge region which gives way to the upper opening, and an outer part with a bottom and a circumferential cylindrical side wall which has an upper edge region. The inner part is arranged in the outer part in such a way that the upper edge region of the outer part surrounds the side wall of the inner part. The inner part projects beyond the outer part by way of its upper edge region and forms the single-walled upper region of the glass vessel.

The glass vessel can be produced in a simple manner by arranging the inner part in the outer part. Since the inner part projects out of the outer part, the two parts are not connected at their respective upper edges. Instead, the two parts are connected only in the upper edge region of the outer part, wherein the upper edge region of the outer part comes to rest against the circumferential side wall of the inner part. As a result, stresses are avoided and the measuring accuracy of the inner face of the inner part is maintained very well. The inner part and the outer part are preferably connected to one another solely by this fused connection, that is to say there is no further connection, for example in the region of the bottom.

The bottom of the outer part can have a pressure-compensating opening which is closed by a stopper, preferably comprising a polymer, for example a drop of adhesive.

In order to achieve the greatest possible security and insulation, the glass vessel is of continuously double-walled designed at least in a region of its side wall, but preferably all over. In this case, forming the pouring aid is a particular challenge. This is preferably achieved in that the glass vessel has an inner part and an outer part, wherein an outwardly projecting inner spout region is formed in the inner part and a corresponding outer spout region, which likewise projects outward, is formed in the outer part, wherein the inner spout region projects into the outer spout region. The inner spout region and the outer spout region are then fused to one another along a common edge.

The glass vessel is preferably used in a beverage-making device, in particular for coffee or tea, which has a filter piston. This filter piston can be displaced in the glass vessel and is designed to retain the solids, in particular coffee grounds or tea leaves, in a region of the glass vessel which is close to the bottom. The filter piston is preferably connected to a lid for closing the upper opening in the inner part, which lid may also again be double-walled.

In the method of manufacture according to the invention, the inner part and the outer part are preferably manufactured separately in a first step.

At least the inner part is preferably manufactured by machine in order to keep tolerances in terms of the inside diameter low, so that a plunger filter can be passed through the inner part without obstruction. The outer part can likewise be manufactured by machine or be blown (by mouth). In a second step, the inner part is inserted into the outer part. In a third step, the outer part is fused to the inner part at least in an upper edge region. Further processing steps may precede, be interspersed between, or follow these operations.

According to a first variant, the outer part is heated in an upper edge region and deformed against a side wall of the inner part in the third step, so that the outer part is fused to the inner part in this region. A single-walled upper region of the glass vessel is formed as a result, this single-walled upper region being formed by the upper region of the inner part. A spout shape is then preferably formed in this region under the action of heat.

During fusing of the inner and outer parts, the outer part can be held on a glass tube which extends axially away from the bottom of the outer part. The glass tube also serves for pressure compensation in the intermediate space between the inner and outer parts during heating and cooling. The tube is then removed, wherein an opening can form in the bottom of the outer part. In other production methods, an opening of this kind may also be provided as a pressure-compensating opening. In a further step, this opening is preferably closed in the bottom of the outer part, for example by a liquid curable polymer being added to the opening. If the glass vessel is continuously double-walled, it is difficult to form a pouring aid since this has to be formed both in the inner part and in the outer part. One option is to form the spout regions in the inner part and outer part separately and then fuse them. However, this is difficult on account of the large tolerances when forming the individual spout regions. It is also possible, albeit difficult and associated with large tolerances, to form the spout region only after fusing of the inner part and outer part. It is therefore proposed to first form a spout region only in the upper edge region of the outer part before the joining operation. The upper edge region of the outer part, with the exception of the outer spout region, is then fused to the inner part. An inner spout region is only then formed in the inner part in such a way that the inner spout region projects into the outer spout region, and the inner and the outer spout regions are fused to one another in a common edge region. As a result, the shape of the outer spout region is predefined, and this region can be preformed, for example by machine. The inner spout region can then, in a way, nestle in the outer spout region.

### BRIEF DESCRIPTION OF THE DRAWINGS

The invention will be described in greater detail below using exemplary embodiments and with reference to the drawings, in which:

FIG. 1 shows a perspective view of a glass vessel according to the present invention;

FIG. 2 shows a sectional view along the center axis of the vessel of FIG. 1;

FIG. 3 shows a sectional view of the vessel of FIG. 1 with a filter piston,

FIG. 4 shows a sectional view of the vessel of FIG. 1 with a filter piston and a frame with a handle, and

FIG. 5 shows a sectional view of a glass vessel according to a further embodiment.

### DESCRIPTION OF PREFERRED EXEMPLARY EMBODIMENTS

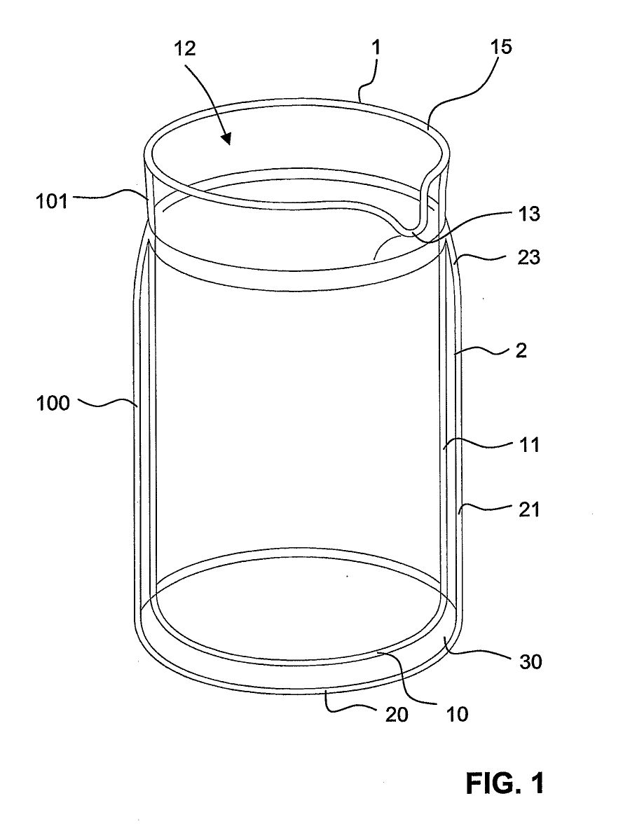

FIG. 1 shows a perspective view of a glass vessel according to the present invention. The vessel comprises an inner part 1 and an outer part 2.

The inner part 1 is of substantially cylindrical configuration and comprises a bottom 10 and a circumferential side wall 11.

The bottom 10 is arranged in a lower region of the inner part 1. The bottom 10 is connected to the side wall 11 by means of a transition 14 which is configured as a rounded transition 14 in this case. The side wall 11 extends perpendicular to the bottom 10 and is of cylindrical configuration. In an upper region, the side wall 11 ends with an upper edge 15. The bottom 10 and the side wall 11 form the boundaries of a hollow space 12. The hollow space 12 serves to hold a liquid. In addition, a spout 13 is formed in the upper region. The spout 13 is configured such that a beverage can be removed as far as possible without drops forming.

The outer part 2 is substantially likewise of cylindrical configuration and likewise comprises a bottom 20 and a side wall 21. The bottom 20 is connected to the side wall 21 by means of a transition 24 which is configured as a rounded transition in this case. The side wall 21 extends perpendicular to the bottom 20. An upper shaped region 23 forms an upper termination. The side wall 21 of the outer part 2 is bent toward the inner part in this region. In other words, the outer part 2 tapers in the direction of the inner part 1 at the top. Analogously to the inner part 1, a hollow space 22 is bounded by the bottom 20 and the side wall 21.

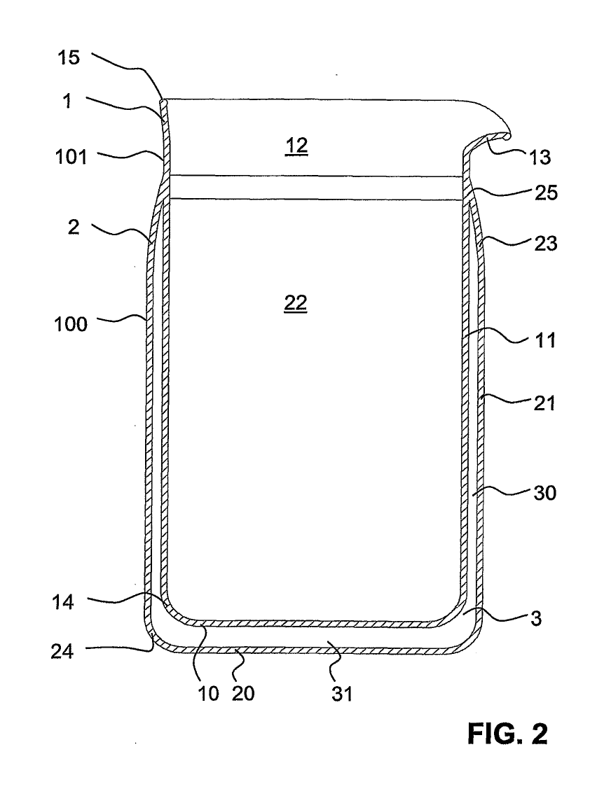

As can be clearly seen in FIG. 2, the hollow space of the outer part 2 has an inside diameter which is greater than the outside diameter of the cylindrical side wall 11 of the inner part 1. Furthermore, the inner part 1 has a greater height than the outer part 2.

During production of the vessel, the inner part 1 and a blank of the outer part 2 are initially in each case produced in a known manner from glass, preferably transparent glass. The blank differs from the outer part of FIGS. 1 and 2 in that its side wall is continuously cylindrical, whereas, after the outer and inner part are joined, the upper region 23 is inclined such that it tapers conically in the direction of the inner part.

The inner part 1 is inserted into the hollow space 22 of the outer part 2 which still has the shape of the blank. The inner part 1 is positioned concentrically to the outer part 2. On account of the corresponding diameter ratios, a first intermediate space 30 forms between the cylindrical side walls 11, 21. Furthermore, the inner part 1 is positioned in the outer part 2 in such a way that the bottom 10 of the inner part 1 does not touch the bottom 20 of the outer part 2, and that an upper region 101 of the inner part 1 projects out of the outer part 2. Therefore, a second intermediate space 31 forms between the bottom 20 of the outer part 2 and the bottom 10 of the inner part 1. The first intermediate space 30 and the second intermediate space 31 merge with one another in the regions of the transitions 14 and 24 and form a continuous intermediate space 3. The intermediate space 3 serves later as a thermal insulation means.

Since the inner part 1 has a greater height than the outer part 2, the upper region of the inner part 1 projects beyond the outer part 2. The resulting vessel is therefore of double-walled configuration in a lower region 100 and of single-walled configuration in an upper region 101.

The outer part 2 is connected to the inner part 1 in the upper region 23 of the outer part. In this case, the upper region 23 of the outer part is deformed against the cylindrical side wall 11 of the inner part and then fused to the side wall 11. On account of this fused connection, the upper region 23 now has the conically tapering form of FIGS. 1 and 2. The connection between the inner part 1 and the outer part 2 is of air-tight configuration.

During deformation and fusing of the outer part 2 to the inner part 1, the air in the intermediate space 30 heats up due to heating of the outer part 2, and the air therefore expands. This heated air can leave the intermediate space 3 via a small, preferably centrally arranged opening (not illustrated) in the bottom 20 of the outer part. This small opening can also be termed a pressure-compensating opening.

After the vessel has cooled down, the opening in the bottom 20 of the outer part is closed, for example with an adhesive plug or a stopper comprising a flexible plastic, for example silicon rubber. As a result, undesired infiltration by a liquid, for example dishwashing water, into the intermediate space 30 through the opening can be prevented.

The intermediate space 3 can be filled with various media or evacuated. The intermediate space 3 is preferably filled with normal ambient air. As an alternative, other gases, for example dry nitrogen, or a liquid can be introduced before closing. A solid, for example an insulating foam or colored particles, can also be arranged in the intermediate space.

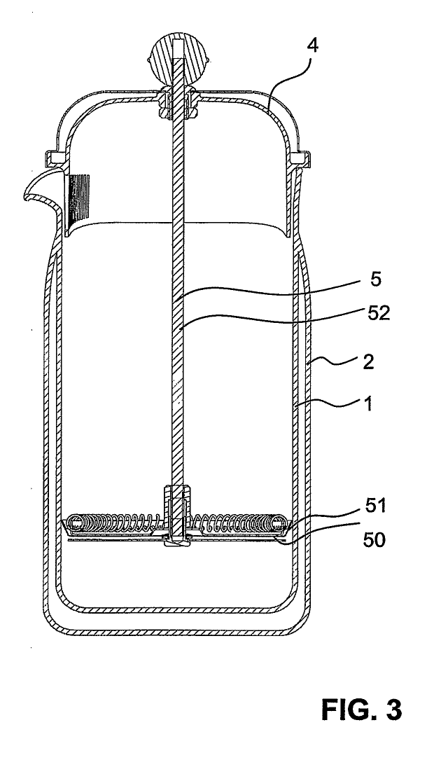

FIG. 3 shows the vessel according to the invention in a coffee maker. To this end, a lid 4 with a filter piston 5 is inserted into the vessel. The filter piston 5 comprises a filter plate 50, which is provided with fine openings, and a piston rod 52 which is associated with said filter plate. The piston rod 52 can be used to displace the filter plate in the hollow space 12 within the cylindrical side wall 11. The filter plate 50 extends slightly beyond the inside diameter of the cylindrical inner part 1 in the non-inserted state. In the inserted state, an edge 51 ensures that a region above the filter plate 50 is sealed off from a region below the filter plate 50. After coffee powder is infused, the filter piston 5 can then be inserted into the inner part 1 and pushed in the direction of the bottom 10. In this case, the coffee grounds are separated from the infused coffee liquid. The coffee grounds are then located between the filter plate 50 and the bottom 10 of the inner part 1. Similarly, use with tea leaves is also possible.

Under unfavorable conditions, there is a risk of the inner part 1 breaking in the lower region when the filter piston 5 is pushed down. This can occur when, for example, coffee powder which is not ground to the optimum degree is used and the user operates the piston rod 52 with great force. If the inner part 1 breaks, a hot jet of liquid enters the intermediate space 3 through the broken point at high speed. This jet can then be retained by the outer part 2. This prevents the user being injured by the hot jet of liquid. If, in the worst-case scenario, the outer part 2 breaks too, the jet of liquid enters the surroundings. However, on account of passing through the inner part 1, the intermediate space 3 and the outer part 2, the jet of liquid is slowed down to such an extent that the risk of injury to the user is largely reduced or is completely eliminated. Conversely, the double-walled configuration also provides improved protection against scalding if the outer part should be damaged.

An upper part of the lid 4, which projects out of the double-walled glass vessel in the inserted state, is also of double-walled configuration. However, a single-walled lid can also be used.

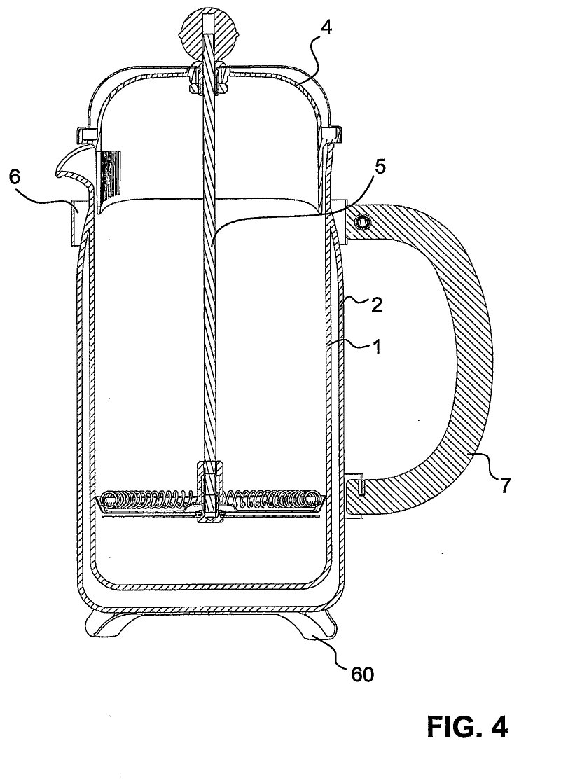

FIG. 4 shows the vessel of FIG. 3 with the addition of a frame 6 and a handle 7. The frame 6 surrounds the vessel around the outer part 2 and is connected to the handle 7. Feet 61, on which the vessel can stand, are integrally formed on the frame 6. The frame is arranged such that it covers the weld seam, that is to say the point at which the outer part and the inner part are fused to one another. This firstly protects the weld seam, and secondly this is also desirable for aesthetic reasons since this seam does not always run uniformly and is not always visually pleasing. However, it is also possible for the frame to be arranged in some other way. In particular, the frame can be disposed above or below the weld seam.

A handle can also be attached to the vessel in another way, for example by means of a metal strip which surrounds the upper region of the vessel. A handle can also be integrally formed directly on the outer part or be directly connected to the outer part in some other way. For example, a glass handle can be fused directly to the outer part.

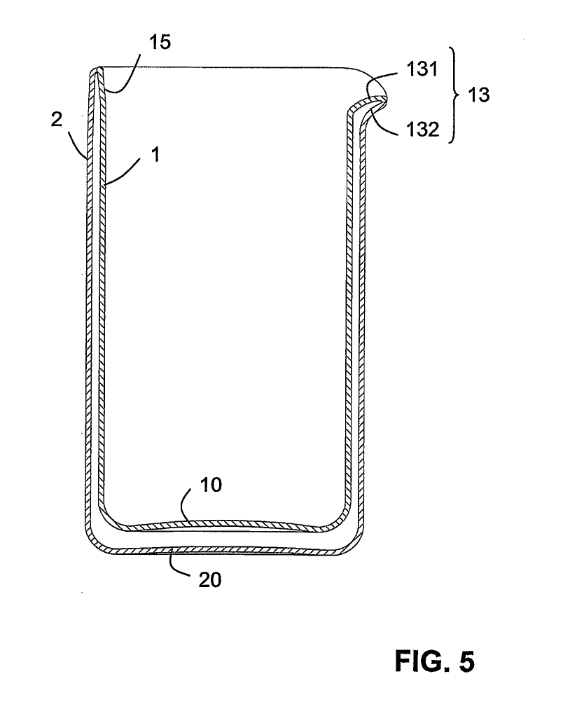

An alternative embodiment is illustrated in FIG. 5. In this variant, the outer part 2 is drawn up to the upper edge of the inner part 1. The inner and outer parts are fused to one another along their upper edges. The bottoms 10, 20 of the inner part 1 and of the outer parts 2 are curved slightly inward, that is to say concavely. The upper edge region of the inner part 1 expands slightly in the outward direction, that is to say the inside diameter of the inner part 1 increases in the upward direction. As a result, a filter piston can be inserted more easily into the vessel.

A spout region 13 is present as a pouring aid in the upper edge region of the vessel. This spout region is formed by an inner spout region 131 on the inner part 1 and an outer spout region 132 on the outer part 2. In this case, the outer spout region 132 is preferably already preformed, for example by machine or manually by pressing it against a mold, before the inner part is inserted into the outer part. The inner part, which still does not have a spout region, is then inserted into the outer part. The inner part is fused to the outer part, except in the region in which the outer spout region is present, along its upper edge. The inner spout region is then formed by heating and deformation on the inner part, wherein this spout region, so to speak, nestles against the outer spout region. The two regions are then likewise fused, so that the inner part and outer part are fused to one another circumferentially.

In the above exemplary embodiments, the inner part 1 and the outer part 2 have a round (circular) cross-sectional shape. The round cross-sectional shape is produced by the circular-cylindrical basic shape. However, it is also possible for the outer part and/or the inner part to have any desired cross-sectional shape. However, if the double-walled vessel is used as a coffee maker, it is advantageous, on account of the filter plate, for the inner part 1 to be of circular-cylindrical configuration.

In further exemplary embodiments, it is additionally possible for the inner part 1 and the outer part 2 to have different cross-sectional shapes. For example, the inner part 1 can have a round basic shape and the outer part 2 can assume an elliptical basic shape. It goes without saying that angular cross-sectional shapes are also feasible. This can lead to interesting visual effects.

### LIST OF REFERENCE SYMBOLS

1 Inner part
2 Outer part
3 Intermediate space
4 Lid
5 Filter piston
6 Frame
7 Handle
10 Bottom
11 Side wall
12 Hollow space
13 Spout
14 Transition
15 Upper edge region
100 Lower region
101 Upper region
131 Upper spout region
132 Lower spout region
20 bottom
21 Side wall
22 Hollow space
23 Shaped region
24 Transition
25 Weld point
30 First intermediate space
31 Second intermediate space
50 Filter plate
51 Edge
52 Piston rod
61 Feet

1. A glass vessel for a beverage-making device, the vessel being open at the top and being at least partly of double-walled design.

2. The glass vessel as claimed in claim 1, the glass vessel comprising an inner part and an outer part which at least partly surrounds said inner part, the inner part and the outer part being fused to one another.

3. The glass vessel as claimed in claim 1, the glass vessel comprising an inner part and an outer part which at least partly surrounds said inner part, at least one of the inner part and the outer part tapering toward the respectively other part in an upper edge region.

4. The glass vessel as claimed in claim 1, the glass vessel comprising an inner part and an outer part which at least partly surrounds said inner part, the inner part widening in an upper edge region.

5. The glass vessel as claimed in claim 1, the glass vessel having a single-walled upper region which is close to the opening and a double-walled lower region which adjoins said single-walled upper region.

6. The glass vessel as claimed in claim 5, wherein a spout shape his formed in the single-walled upper region.

7. The glass vessel as claimed in claim 1, comprising
an inner part with a bottom and a circumferential side wall which has an upper edge region which gives way to an upper opening, and
an outer part with a bottom and a circumferential side wall which has an upper edge regional,
wherein the inner part his arranged in the outer part in such a way that the upper edge region of the outer part surrounds the side wall of the inner part, and the inner part projects beyond the outer part by way of its upper edge region and forms a single-walled upper region of the glass vessel.

8. The glass vessel as claimed in claim 7, wherein the inner part and the outer part are connected to one another by a fused connection between the upper edge region of the outer part and the side wall of the inner part.

9. The glass vessel as claimed in claim 1, wherein the glass vessel is of continuous double-walled design at least in the region of its side wall.

10. The glass vessel as claimed in claim 9, the glass vessel comprising an inner part and an outer part, wherein an inner spout region is formed in the inner part, wherein an outer spout region is formed in the outer part, and wherein the inner spout region and the outer spout region are fused to one another along a common edge.

11. A beverage-making device comprising a glass vessel as claimed in claim 1 and a filter piston which can be displaced in the glass vessel and is designed to retain solids in a region of the glass vessel which is close to the bottom.

12. The beverage-making device as claimed in claim 11, wherein the filter piston is connected to a double-walled lid in order to close the upper opening in the inner part.

13. A method for producing a glass vessel comprising:
manufacturing an inner part,
manufacturing an outer part separately from said inner part,
inserting the inner part into the outer part and
fusing the outer part to the inner part at least in an upper edge region.

14. The method as claimed in claim 13, wherein the step of fusing comprises:
heating the outer part in its upper edge region and deforming the outer part against a side wall of the inner part, so that the outer part his fused to the inner part in this region and a single-walled upper region of the glass vessel is produced.

15. The method as claimed in claim 14, comprising:
forming a spout shape in the single-walled upper region of the glass vessel under the action of heat.

16. The method as claimed in claim 13, comprising:
forming an outwardly projecting outer spout region in the upper edge region of the outer part before joining said inner part and said outer part,
fusing the upper edge region of the outer part, with the exception of the outer spout region, to an upper edge of the inner part,
forming an inner spout region in the inner part in such a way that the inner spout region projects into the outer spout region, and wherein
fusing the inner and the outer spout regions to one another in a common edge region.
